(19) United States
(12) Patent Application Publication
(10) Pub. No.: US 2004/0184144 A1
(43) Pub. Date: Sep. 23, 2004

(54) Wavelength-specific phase microscopy

(76) Inventor: Paul C. Goodwin, Shoreline, WA (US)

Correspondence Address: Pillsbury Winthrop LLP, Intellectual Property Group, Suite 200, 11682 El Camino Real., San Diego, CA, 92130-2092, US

(21) Appl. No.: 10/742,507

(22) Filed: Dec. 19, 2003

Related U.S. Application Data
(60) Provisional application No. 60/437,269, filed on Dec. 31, 2002.

(51) Int. Cl. G02B 21/06

(52) U.S. Cl. 359/386; 359/371

(57) ABSTRACT

A system and method of generating and acquiring phase contrast microscope images without interfering with the intensity and optical quality of other microscopy modalities employ wavelength-specific illumination and attenuation strategies for phase microscopy applications. A wavelength-specific objective phase ring that is opaque only at specific wavelengths may be used in conjunction with a phase microscopy apparatus. Attenuated wavelengths may be controlled such that opacity may be selectively provided only with respect to wavelengths that are outside of the desired range for the fluorescence signals being monitored. Illumination within the opaque wavelength range for the objective phase ring may be selected for phase microscopy applications. Accordingly, an objective phase ring effective for enabling wavelength-specific phase microscopy may not interfere with normal usage of the microscope for other applications such as, for example, fluorescence microscopy.

### CROSS-REFERENCE TO RELATED APPLICATIONS

The present application claims the benefit of U.S. provisional application Serial No. 60/437,269, filed Dec. 31, 2002, entitled “NEAR-INFRARED PHASE MICROSCOPY SYSTEM AND METHOD.”

### FIELD OF THE INVENTION

Aspects of the present invention relate generally to phase microscopy imaging systems, and more particularly to a system and method employing wavelength-specific illumination and attenuation strategies for phase microscopy applications.

### DESCRIPTION OF THE RELATED ART

When performing fluorescence microscopy on living cells, tissues, and organisms, it is often desirable to obtain structural information from the sample. For example, when studying the localization of protein constructs within a living cell using fluorescent proteins such as Green Fluorescent Protein (GFP), it is often desirable to describe these localizations within the context of the boundary of the cell. The cells themselves are most often devoid of inherent absorptions of light, so visualization with white light is not sufficient in many instances. Accordingly, microscopists often use methods that generate contrast by exploiting refractive index gradients between the cell and its environment and between individual organelle boundaries. The most common methods in the art for generating such contrast are differential interference contrast (DIC) microscopy and phase contrast (phase) microscopy. These methods attempt to strike a balance between two often incompatible goals: detecting fluorescence emissions with a signal to noise ratio sufficient to enable careful and thorough study, on the one hand; and minimizing or otherwise controlling potentially damaging effects of the light illuminating the cell, on the other hand.

Of the two methods mentioned above for generating contrast, DIC microscopy is most often selected for fluorescence applications because DIC techniques can be configured in such a way that the intensity of the fluorescent signal is neither significantly reduced nor degraded, maximizing the signal to noise ratio in many situations. Recent studies have demonstrated, however, that DIC microscopy introduces spatial artifacts into fluorescence microscopy systems by altering the Point Spread Function (PSF) of the optical train. This artifact is particularly disadvantageous because it is an asymmetrical blurring of the PSF, rendering correction of the optical effect through mathematical techniques such as digital deconvolution very difficult.

In phase microscopy, opaque annuli, or “phase rings,” are inserted at specific locations in the optical path. Phase rings having appropriate attenuation characteristics enable generation of contrast at interfaces between materials of different refractive indices by exploiting the phase differences between the light that passes through one material versus another. The introduction of phase rings, however, also interferes with the total intensity of the light collected by the microscope because some of the light that would normally pass through the objective lens is attenuated by one or more of the rings. Consequently, phase microscopy is most often not utilized with fluorescence microscopy applications.

Conventional technology is deficient at least to the extent that the best contrast generating method for use in conjunction with fluorescence microscopy applications tends to distort the very fluorescence whose localization is under investigation. What is needed is a phase contrast technique optimized for fluorescence microscopy.

### SUMMARY

Embodiments of the present invention overcome the above-mentioned and various other shortcomings of conventional technology, providing a system and method employing wavelength-specific illumination and attenuation strategies for phase microscopy applications.

In accordance with one embodiment, for example, a method as disclosed herein may comprise: providing illumination from a source to a microscopy apparatus having a condenser phase ring and an objective phase ring; selectively limiting the illumination incident on the condenser phase ring to a predetermined range of wavelengths; and selectively attenuating emission light incident on the objective phase ring at the predetermined range of wavelengths.

The selectively limiting may comprise utilizing a wavelength-specific source of illumination such as a light emitting diode or a laser. Additionally or alternatively, the selectively limiting may comprise interposing a wavelength-specific optical filter between the source and the condenser phase ring. In some exemplary embodiments having functional flexibility, the selectively limiting comprises limiting the illumination to near-infrared wavelengths, such as, for example, wavelengths above approximately 650 nm.

A system configured and operative in accordance with the present disclosure may comprise: a microscopy apparatus; an excitation light delivery system comprising an illumination source; the excitation light delivery system operative to deliver light in a selected range of wavelengths from the source to the microscopy apparatus; and an objective phase ring coupled to an objective lens of the microscopy apparatus; the objective phase ring operative selectively to attenuate light in the selected range of wavelengths.

In some embodiments, the excitation light delivery system comprises a wavelength-specific illumination source operative to produce excitation light in the selected range of wavelengths. As noted above, such a wavelength-specific illumination source may be embodied in or comprise a light emitting diode or a laser. Additionally or alternatively, the excitation light delivery system may comprise a wavelength-specific optical filter interposed between the source and the microscopy apparatus; in these embodiments, the wavelength-specific optical filter is operative selectively to transmit excitation light in the selected range of wavelengths.

As noted above with reference to exemplary methods, the selected range of wavelengths comprises near-infrared wavelengths in some embodiments. In one particular implementation, the selected range of wavelengths includes near-infrared wavelengths above 650 nm.

As set forth in more detail below, another exemplary system is described comprising: an illumination source; and a microscopy system receiving illumination from the source and having a condenser phase ring and an objective phase ring; wherein the source provides the illumination to the condenser phase ring at a predetermined range of wavelengths and wherein the objective phase ring is operative selectively to attenuate light in the predetermined range of wavelengths. The source may be a light emitting diode or a laser.

The foregoing and other aspects of various embodiments of the present invention will be apparent through examination of the following detailed description thereof in conjunction with the accompanying drawings.

### BRIEF DESCRIPTION OF THE DRAWINGS

FIG. 1 is a simplified block diagram illustrating components of a conventional phase microscopy system.

FIG. 2 is a simplified block diagram illustrating components of one embodiment of a wavelength-specific phase microscopy system.

FIGS. 3A and 3B are simplified diagrams illustrating opacity of an objective phase ring in a conventional phase microscopy system and in one embodiment of a wavelength-specific phase microscopy system, respectively.

FIG. 4 is a simplified plot illustrating opacity of one embodiment of an objective phase ring as a function of wavelength.

FIG. 5 is a simplified flow diagram illustrating the general operation of one embodiment of a wavelength-specific phase microscopy method.

### DETAILED DESCRIPTION

Aspects of the present invention relate to generating and acquiring phase contrast microscope images without interfering with the intensity and optical quality of other microscopy modalities, and without requiring the removal of any optical components. As set forth in more detail below, instead of using an entirely opaque annulus in the back focal plane of the objective, a selectively opaque annulus (i.e., an objective phase ring that is opaque only at specific wavelengths) may be used. In accordance with the structural arrangements set forth herein, attenuated wavelengths may be selectively controlled, i.e., opacity may be selectively provided only with respect to wavelengths that are outside of the desired range for the fluorescence signals being monitored. Illumination within the opaque wavelength range for the objective phase ring may be selected for phase microscopy applications. Accordingly, an objective phase ring effective for enabling wavelength-specific phase microscopy may not interfere with normal usage of the microscope for other applications such as, for example, fluorescence microscopy.

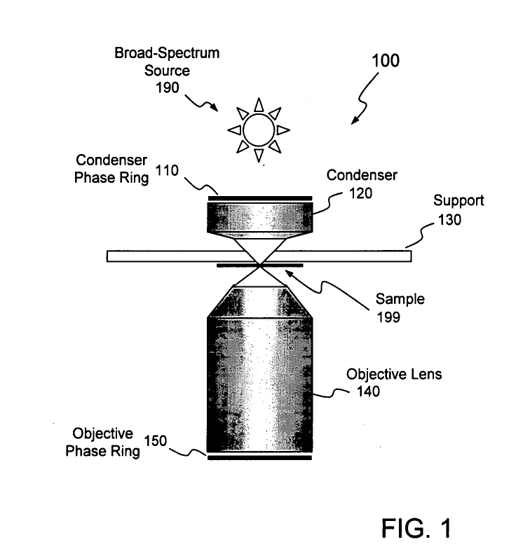

Turning now to the drawing figures, FIG. 1 is a simplified block diagram illustrating components of a conventional phase microscopy system. As illustrated in FIG. 1, a phase microscopy system 100 generally comprises an illumination source 190 configured and operative to provide illumination or excitation light. Such excitation light passes through an illumination or condenser phase ring 110 and condenser optics 120 to illuminate specimen material (sample 199) maintained, for example, on a microscope slide, a biological chip (bio-chip), or other apparatus supported, attached, or otherwise disposed at a support 130. In that regard, support 130 may generally be embodied in or comprise a movable microscope stage, for example. Light emitted from, or transmitted through, sample 199 is collected by an objective lens 140 and passed to an objective phase ring 150. As various components of system 100 are generally known in the art, an exhaustive description of the functionality and interoperability these components for phase microscopy applications is not provided here. The following description is not intended to be construed as limiting the contexts and environments in which embodiments of the invention have utility.

Illumination source 190 is typically a broad-spectrum light source, generating light across the entire visible range (or substantially all of the visible range) of the electromagnetic spectrum, i.e., a wavelength range from approximately 300 nm to approximately 700 nm. Condenser phase ring 110 and objective phase ring 150 are substantially opaque for all visible wavelengths. Those of skill in the art will appreciate that “substantially opaque,” in this context, generally refers to the ability of condenser phase ring 110 and objective phase ring 150 to attenuate all, or a desired percentage of, light in the visible range or some specified range of wavelengths. In that regard, condenser phase ring 110 and objective phase ring 150 selectively limit transmission of electromagnetic energy at particular wavelengths; in the case of system 100 employing objective phase ring 150, this range of wavelengths is usually approximately 300 nm—700 nm as set forth above.

During operation of system 100, excitation light from source 190 illuminates the specimen or sample 199 disposed on support 130. Condenser phase ring 110 and objective phase ring 150 are aligned such that light passing through objective lens 140 (emission light) that is substantially unchanged in phase is largely attenuated by objective phase ring 150, while light that is substantially changed in phase is accentuated. Since condenser phase ring 110 and objective phase ring 150 are opaque across a broad spectrum of wavelengths, the phase image of light passing through objective phase ring 150 is polychromatic. Further, since objective phase ring 150 is opaque across the visible spectrum, any visible light that is transmitted through objective lens 140 will be selectively attenuated to some degree, limiting the intensity of emission light for all applications of system 100.

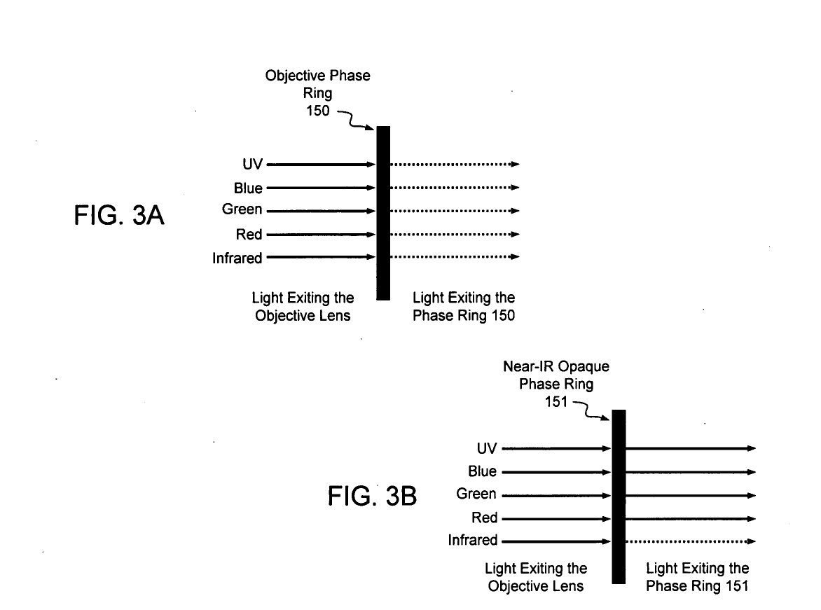

Specifically, if system 100 is intended for use in other modalities of microscopy in addition to phase microscopy applications (e.g., such as fluorescence microscopy), objective phase ring 150 may also attenuate signals from those selected modalities. In that regard, FIG. 3A is a simplified diagram illustrating opacity of an objective phase ring in a conventional phase microscopy system. As indicated in FIG. 3A, light emitted or transmitted by sample 199 and exiting objective lens 140 (represented by the solid lines on the left side of FIG. 3A) is attenuated (as indicated by the dotted lines) by objective phase ring 150 regardless of wavelength. The functional utility and flexibility of system 100 employing objective phase ring 150 is generally limited accordingly.

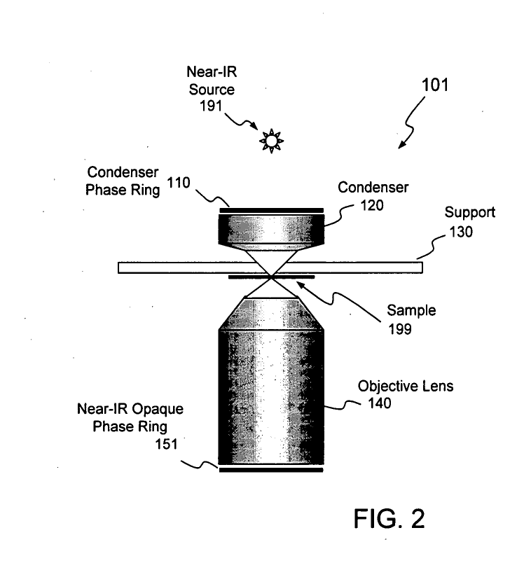

FIG. 2 is a simplified block diagram illustrating components of one embodiment of a wavelength-specific phase microscopy system configured and operative in accordance with the present disclosure. As illustrated in FIG. 2, a wavelength-specific phase microscopy system 101 may generally comprise a near-infrared illumination source 191 providing excitation light in a limited range of wavelengths. Such excitation light passes through condenser phase ring 110 and condenser 120 to illuminate sample 199 disposed at support 130 as described above. Emission light from sample 199 is collected by objective lens 140 and passed to a near-infrared opaque objective phase ring 151.

In the exemplary FIG. 2 arrangement, excitation light incident on condenser phase ring 110 is selectively limited to a desired range of wavelengths by near-infrared source 191. In that regard, source 191 may be embodied in or comprise a light emitting diode (LED) or laser, for example, or any other source capable of generating electromagnetic energy having appropriately limited frequency and wavelength characteristics. It is noted, however, that other embodiments may not rely exclusively upon an LED or other source of substantially monochromatic light such as source 191.

By way of example, a wavelength-specific optical filter or a filter array may be interposed in the light path between broad-spectrum light source 190 and condenser phase ring 110 to achieve an effect similar to providing light from near-infrared source 191, ie., selectively limiting the excitation light incident on condenser phase ring 110 to a desired range of wavelengths, such as from the near-infrared portion of the spectrum. Any of various short-pass or band-pass optical filters known in the art or developed and operative in accordance with known principles may provide wavelength specificity suitable for selectively passing a predetermined wavelength of excitation light to condenser phase ring 110.

Appropriately limited (i.e., wavelength-specific) excitation light incident on condenser phase ring 110 may be transmitted in part to illuminate sample 199. In particular, the phase of excitation light transmitted by condenser phase ring 110 may be controlled through appropriate materials or coatings as generally known in the art.

In accordance with some embodiments of wavelength-specific phase microscopy system 101, objective phase ring 151 may be fabricated of a material having an opacity that is wavelength-specific. Additionally or alternatively, objective phase ring 151 may be fabricated to include or incorporate an interference coating of appropriate material and orientation to achieve any desired wavelength-specific opacity. Various methods of constructing phase rings and applying coatings thereto are generally known in the art of optics and optical component design. The present disclosure is not intended to be limited to any particular material, coating technique, or design parameters with respect to manufacture and preparation of objective phase ring 151 or condenser phase ring 110.

Objective phase ring 151 may be situated or disposed at the back aperture of objective lens 140. In one exemplary embodiment, objective phase ring 151 may be substantially transparent to all visible wavelengths with the exception of those near the infrared (e.g., in the wavelength range from approximately 650 nm to approximately 900 nm). Conversely, in those wavelengths that are near-infrared (e.g., 650—900 nm), objective phase ring 151 may be substantially opaque. In that regard, FIG. 3B is a simplified diagram illustrating opacity of an objective phase ring in a wavelength-specific phase microscopy system. As indicated in FIG. 3B, visible light from sample 199 exiting objective lens 140 (represented by the solid lines on the left side of FIG. 3B) may be transmitted freely through objective phase ring 151 substantially without attenuation (as indicated by the solid lines on the right side of FIG. 3B), while light near the infrared is attenuated (as indicated by the dotted line) by objective phase ring 151.

With specific reference to system 101, condenser phase ring 110 may be opaque with respect to all or most visible wavelengths substantially as described above. In some exemplary implementations, excitation light from source 191 may be provided substantially in the near-infrared wavelengths; additionally or alternatively, a combination of broad-spectrum source 190 and one or more filters may be employed to restrict the excitation light to the appropriate or desired wavelengths (such as, for example, near-infrared wavelengths). Light that is not shifted in phase by sample 199 may be attenuated by objective phase ring 151, while light that is shifted in phase may be accentuated by objective phase ring 151. In accordance with the foregoing, any such accentuated light exiting objective phase ring 151 will generally be restricted to the longer wavelengths generated by near-infrared source 191 (or by some combination of broad-spectrum source 190 and one or more wavelength-specific filter mechanisms) as set forth above.

It will be appreciated that light from other modalities (e.g., such as fluorescence) passing through objective lens 140 may remain unaffected by operation of objective phase ring 151, unless the modality is operative with light near the opaque range of objective phase ring 151, i.e., near-infrared (approximately 650 nm—900 nm) in the embodiment of FIGS. 2 and 3B, or some other specified or predetermined wavelength or range.

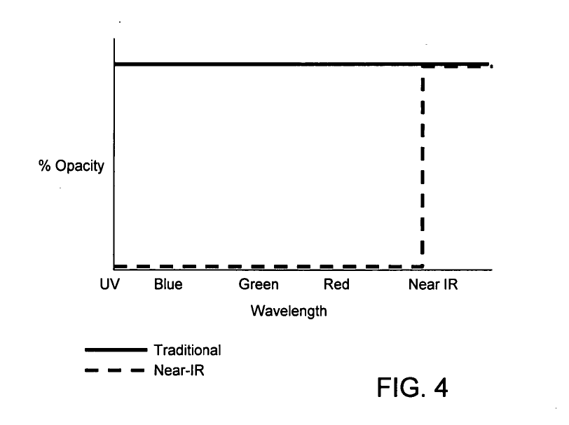

FIG. 4 is a simplified plot illustrating opacity of one embodiment of an objective phase ring as a function of wavelength. As indicated by the dark solid horizontal line at the upper portion of the plot, a traditional objective phase ring 150 exhibits constant opacity, irrespective of the wavelength of light transmitted by the objective lens. A wavelength-specific objective phase ring 151, on the other hand, exhibits a marked difference in opacity at a specified wavelength or range of wavelengths. In the exemplary embodiment of FIGS. 2-4, objective phase ring 151 is operative to exhibit wavelength-specific attenuation properties at the same wavelengths at which excitation light is produced by source 191 or combination of source and filters, i.e., the near-infrared range of approximately 650 nm and above. As set forth above, wavelength specificity may be achieved by the materials selected for objective phase ring 151, various coating techniques, or some combination thereof.

A wavelength-specific opacity profile such as illustrated by the dashed line in FIG. 4 may be achieved in wavelengths outside the near-infrared range. Specifically, in some implementations, objective phase ring 151 may be constructed and operative to exhibit chromatically specific opacity at wavelengths outside the near-infrared range. In accordance with one aspect of the functionality of system 101 set forth above, objective phase ring 151 may exhibit wavelength-specific opacity at the same wavelengths of the light incident on condenser phase ring 110, irrespective of whether that excitation light is provided directly from a wavelength-specific source such as source 191, or from a combination of broad-spectrum illumination source 190 and optical filters.

As contemplated in the exemplary embodiments, the near-infrared range has been selected and described because such wavelengths provide minimal interference with fluorescence signals which are of particular interest in biological imaging, especially that of auto-fluorescent proteins, for example. Accordingly, system 101 employing objective phase ring 151 may have additional utility and increased flexibility in applications other than phase microscopy; fluorescence microscopy experiments, for example, may be conducted with system 101 without requiring removal of objective phase ring 151. It will be appreciated, however, that the present disclosure is not intended to be limited to near-infrared wavelength specificity. In particular, the foregoing functional considerations may be applied to provide wavelength specificity outside the near-infrared range in other contexts and with respect to other applications.

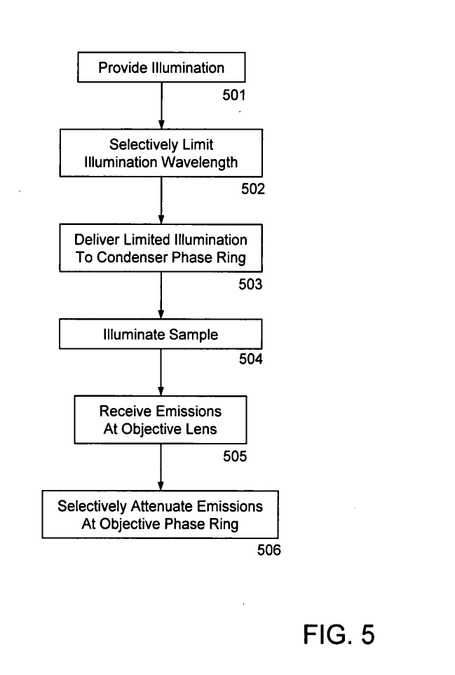

FIG. 5 is a simplified flow diagram illustrating the general operation of one embodiment of a wavelength-specific phase microscopy method. As indicated at block 501, illumination or excitation light may be provided from an illumination source; that illumination may be selectively limited or restricted to a predetermined wavelength or range of wavelengths as indicated at block 502.

As set forth above, such wavelength selection, or selectively limiting the excitation illumination to a predetermined wavelength range, may be combined with or incorporated into the providing operation depicted at block 501. In such embodiments, the illumination source may be selected such that the source itself provides excitation light in a limited range of wavelengths or at a specific predetermined wavelength; examples of sources appropriate for these embodiments include, for example, LEDs or lasers constructed and operative to output electromagnetic energy at a predetermined or desired wavelength. Additionally or alternatively, the limiting operation depicted at block 502 may comprise passing excitation light provided by the source through one or more optical filters operative selectively to transmit electromagnetic energy at predetermined wavelengths while attenuating energy at other wavelengths.

Appropriately provided and wavelength-limited excitation illumination may be delivered to a condenser phase ring as indicated at block 503. In some embodiments, a condenser phase ring for use in wavelength-specific phase microscopy may be substantially opaque across the visible spectrum, or across a substantial portion thereof, generally limiting transmission of visible light having wavelengths in the range from about 300 nm—700 nm. Those of skill in the art will appreciate that other (e.g., more limited or simply different) ranges of opacity may be appropriate for the condenser phase ring, depending up on the functionality of other system components and the desired operational characteristics of the microscopy system in general.

Excitation light having an appropriately limited wavelength (blocks 501 and 502) and an appropriately selected phase (block 503) may be employed to illuminate a sample or specimen material as indicated at block 504; it will be appreciated that such a sample may be supported on a microscope slide or bio-chip as generally known in the art. Emissions from the sample may be received at an objective lens as indicated at block 505.

As indicated at block 506, emission light (i.e., transmitted by the objective lens) may be selectively attenuated by an objective phase ring. As set forth above, such an objective phase ring may be situated at the back aperture of the objective lens, and may cooperate with the condenser phase ring selectively to attenuate light that has not been phase shifted and selectively to accentuate light that has been shifted in phase. Importantly, such accentuated light is generally only at the predetermined wavelength or within the selected range of wavelengths incident on the condenser phase ring as provided and limited at blocks 501 and 502.

Several features and aspects of the present invention have been illustrated and described in detail with reference to particular embodiments by way of example only, and not by way of limitation. Those of skill in the art will appreciate that alternative implementations and various modifications to the disclosed embodiments are within the scope and contemplation of the present disclosure. Therefore, it is intended that the invention be considered as limited only by the scope of the appended claims.

1. A method comprising:
providing illumination from a source to a microscopy apparatus having a condenser phase ring and an objective phase ring;
selectively limiting said illumination incident on said condenser phase ring to a predetermined range of wavelengths; and
selectively attenuating emission light incident on said objective phase ring at said predetermined range of wavelengths.

2. The method of claim 1 wherein said selectively limiting comprises utilizing a wavelength-specific source of illumination.

3. The method of claim 2 wherein said selectively limiting comprises utilizing a light emitting diode.

4. The method of claim 2 wherein said selectively limiting comprises utilizing a laser.

5. The method of claim 1 wherein said selectively limiting comprises interposing a wavelength-specific optical filter between said source and said condenser phase ring.

6. The method of claim 1 wherein said selectively limiting comprises limiting said illumination to near-infrared wavelengths.

7. The method of claim 6 wherein said selectively limiting comprises limiting said illumination to wavelengths above 650 nm.

8. A system comprising:
a microscopy apparatus;
an excitation light delivery system comprising an illumination source; said excitation light delivery system operative to deliver light in a selected range of wavelengths from said source to said microscopy apparatus; and
an objective phase ring coupled to an objective lens of said microscopy apparatus;
said objective phase ring operative selectively to attenuate light in said selected range of wavelengths.

9. The system of claim 8 wherein said excitation light delivery system comprises a wavelength-specific illumination source operative to produce excitation light in said selected range of wavelengths.

10. The system of claim 9 wherein said wavelength-specific illumination source comprises a light emitting diode.

11. The system of claim 9 wherein said wavelength-specific illumination source comprises a laser.

12. The system of claim 8 wherein said excitation light delivery system comprises a wavelength-specific optical filter interposed between said source and said microscopy apparatus.

13. The system of claim 12 wherein said wavelength-specific optical filter is operative selectively to transmit excitation light in said selected range of wavelengths.

14. The system of claim 8 wherein said selected range of wavelengths comprises near-infrared wavelengths.

15. The system of claim 14 wherein said selected range of wavelengths includes near-infrared wavelengths above 650 nm.

16. A system comprising:
an illumination source; and
a microscopy system receiving illumination from said source and having a condenser phase ring and an objective phase ring;
wherein said source provides said illumination to said condenser phase ring at a predetermined range of wavelengths and wherein said objective phase ring is operative selectively to attenuate light in said predetermined range of wavelengths.

17. The system of claim 16 wherein said source is a light emitting diode.

18. The system of claim 16 wherein said source is a laser.
